(19) United States
(12) Patent Application Publication
(10) Pub. No.: US 2024/0242416 A1
(43) Pub. Date: Jul. 18, 2024

(54) REAL-TIME RENDERING GENERATING APPARATUS, METHOD, AND NON-TRANSITORY COMPUTER READABLE STORAGE MEDIUM THEREOF

(71) Applicant: HTC Corporation, Taoyuan City (TW)

(72) Inventors: Sheng-Jie LUO, Taoyuan City (TW); Ssu-Po CHIN, Taoyuan City (TW)

(21) Appl. No.: 18/357,145

(22) Filed: Jul. 23, 2023

Related U.S. Application Data
(60) Provisional application No. 63/438,794, filed on Jan. 13, 2023.

(51) Int. Cl. G06T 15/00; G06T 13/40

(52) U.S. Cl. CPC G06T 15/00; G06T 13/40; G06T 2210/36

(57) ABSTRACT

A real-time rendering generating apparatus, method, and non-transitory computer readable storage medium thereof are provided. The apparatus receives a plurality of character motion data of a plurality of virtual characters. The apparatus determines a rendering level corresponding to each of the virtual characters based on a classification rule related to a first virtual character and the character motion data, each of the rendering levels corresponds to one of a plurality of character level of detail, and each of the plurality of character level of detail corresponds to a range of a customized body part and a skeletal model. The apparatus generates a real-time rendering of each of the virtual characters based on the rendering level corresponding to each of the virtual characters.

### CROSS-REFERENCE TO RELATED APPLICATION

This application claims priority to U.S. Provisional Application Ser. No. 63/438,794, filed Jan. 13, 2023, which is herein incorporated by reference in its entirety.

### BACKGROUND

### Field of Invention

The present invention relates to a real-time rendering generating apparatus, method, and non-transitory computer readable storage medium thereof. More particularly, the present invention relates to a real-time rendering generating apparatus, method, and non-transitory computer readable storage medium thereof for reducing the rendering cost of virtual characters.

### Description of Related Art

In recent years, various technologies related to virtual reality have developed rapidly, and various technologies and applications have been proposed one after another.

In the prior art, a user can enter a world of virtual reality (e.g., metaverse) with his/her virtual character through a device (e.g., a head-mounted display and a controller) to interact.

In such a case, in order to support a large number of users to enter the same virtual reality world, the device of the local user needs more rendering cost to render each of the virtual characters in the scene.

However, as the number of virtual characters becomes larger, a low-end computing device is hard to provide real-time rendering in the virtual world. Furthermore, even a high-end computing device also needs more rendering resources to render all virtual characters in good quality.

Accordingly, there is an urgent need for a real-time rendering generating technology that can reduce the rendering cost of virtual characters.

### SUMMARY

An objective of the present disclosure is to provide a real-time rendering generating apparatus. The real-time rendering generating apparatus comprises a transceiver interface, a storage, and a processor, and the processor is electrically connected to the transceiver interface and the storage. The processor receives a plurality of character motion data of a plurality of virtual characters. The processor determines a rendering level corresponding to each of the virtual characters based on a classification rule related to a first virtual character and the character motion data, each of the rendering levels corresponds to one of a plurality of character level of detail, and each of the plurality of character level of detail corresponds to a range of a customized body part and a skeletal model. The processor generates a real-time rendering of each of the virtual characters based on the rendering level corresponding to each of the virtual characters.

Another objective of the present disclosure is to provide a real-time rendering generating method, which is adapted for use in an electronic apparatus. The real-time rendering generating method comprises the following steps: receiving a plurality of character motion data of a plurality of virtual characters; determining a rendering level corresponding to each of the virtual characters based on a classification rule related to a first virtual character and the character motion data, each of the rendering levels corresponds to one of a plurality of character level of detail, and each of the plurality of character level of detail corresponds to a range of a customized body part and a skeletal model; and generating a real-time rendering of each of the virtual characters based on the rendering level corresponding to each of the virtual characters.

A further objective of the present disclosure is to provide a non-transitory computer readable storage medium having a computer program stored therein. The computer program comprises a plurality of codes, the computer program executes a real-time rendering generating method after being loaded into an electronic apparatus. The real-time rendering generating method comprises the following steps: receiving a plurality of character motion data of a plurality of virtual characters; determining a rendering level corresponding to each of the virtual characters based on a classification rule related to a first virtual character and the character motion data, wherein each of the rendering levels corresponds to one of a plurality of character level of detail, and each of the plurality of character level of detail corresponds to a range of a customized body part and a skeletal model; and generating a real-time rendering of each of the virtual characters based on the rendering level corresponding to each of the virtual characters.

According to the above descriptions, the real-time rendering generating technology (at least including the apparatus, the method, and the non-transitory computer readable storage medium) provided by the present disclosure determines the rendering level of each of a plurality of virtual characters through the corresponding relationship with the user's virtual character. Next, the real-time rendering generating technology provided in the present disclosure can generate the real-time rendering of each of the virtual characters based on the rendering level corresponding to each of the virtual characters. Since the real-time rendering generating technology provided by the present disclosure can classify/assign different rendering levels based on the importance degree between the virtual characters and the virtual character operated by the user, and allows to generate the real-time rendering for each virtual characters based on its own rendering level, and thus the rendering cost of the virtual character is reduced.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1 is a schematic view depicting a real-time rendering generating apparatus of the first embodiment;

FIG. 2 is a schematic view depicting a plurality of character level of detail of some embodiments;

FIG. 3A is a schematic view depicting a plurality of regions of some embodiments;

FIG. 3B is a schematic view depicting a region node graph of some embodiments; and

FIG. 4 is a partial flowchart depicting a real-time rendering generating method of the second embodiment.

### DETAILED DESCRIPTION

In the following description, a real-time rendering generating apparatus, method, and non-transitory computer readable storage medium thereof according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

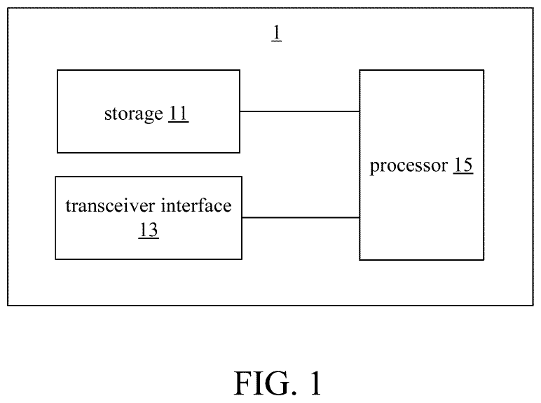

A first embodiment of the present disclosure is a real-time rendering generating apparatus 1 and a schematic view of which is depicted in FIG. 1. The real-time rendering generating apparatus 1 comprises a storage 11, a transceiver interface 13 and a processor 15, wherein the processor 15 is electrically connected to the storage 11 and the transceiver interface 13. The storage 11 may be a memory, a Universal Serial Bus (USB) disk, a hard disk, a Compact Disk (CD), a mobile disk, or any other storage medium or circuit known to those of ordinary skill in the art and having the same functionality. The transceiver interface 13 is an interface capable of receiving and transmitting data or other interfaces capable of receiving and transmitting data and known to those of ordinary skill in the art. The transceiver interface 13 can receive data from sources such as external apparatuses, external web pages, external applications, and so on. The processor 15 may be any of various processors, Central Processing Units (CPUs), microprocessors, digital signal processors or other real-time rendering generating apparatuses known to those of ordinary skill in the art.

It shall be appreciated that in the application environment of the present disclosure, the real-time rendering generating apparatus 1 can be applied to any environment that needs to generate a real-time rendering of each of the virtual characters. In some embodiments, the real-time rendering generating apparatus 1 can be integrated into, but not limited to, a wearable device (e.g., a smart bracelet), a head-mounted display, a mobile electronic device, or other electronic devices operated by a user, and so on.

For the convenience of description, the following will take the real-time rendering generating apparatus 1 installed in the head-mounted display as an example for description, but those with ordinary knowledge in the technical field to which this case belongs should be able to understand the operation method when the real-time rendering generating apparatus 1 is integrated with other devices according to the following description.

In the present disclosure, the local user can use the real-time rendering generating apparatus 1 integrated with the head-mounted display in a physical space (e.g., a room) to perform operations related to virtual reality. In addition, other users can operate their apparatuses in other physical spaces to enter the virtual world to control virtual characters.

In the present embodiment, the processor 15 in the real-time rendering generating apparatus 1 may receive a plurality of character motion data from a plurality of external apparatuses (e.g., apparatuses controlled by other users) through the transceiver interface 13 to calculate the motions of each virtual character and generate real-time rendering of each virtual character in the virtual world. Specifically, the character motion data may comprise all necessary data for calculating the motion of the virtual character in the virtual world, such as movement data of the user's coordinates in the physical space/virtual world, rotation coordinates, transformation parameters, and the like.

In some embodiments, each external apparatus may periodically transmit the character motion data to the real-time rendering generating apparatus 1 based on a predetermined period (e.g., a fixed frequency of 30 times per second).

Next, in the present embodiment, the processor 15 can assign the corresponding rendering level of each virtual character based on the relative relationship or importance degree between these virtual characters and the virtual character operated by the user (hereinafter referred to as: the first virtual character). Specifically, the processor 15 may determine a rendering level corresponding to each of the virtual characters based on a classification rule related to a first virtual character and the character motion data.

It shall be appreciated that in the present embodiment, the processor 15 can pre-set a plurality of character level of detail (Character-LOD), each of the plurality of character level of detail corresponds to a range of a customized body parts and a skeletal model, and each of the rendering levels corresponds to one of the plurality of character level of detail.

It shall be appreciated that when a part of the virtual character is customized (i.e., the content is customized by the user corresponding to the virtual character), the user of the virtual character can choose different details of the part (e.g., hair, glasses, clothes, pants, shoes). Therefore, since the virtual character retains all the details, each part (e.g., hair, glasses, clothes, pants, shoes) is calculated as a separate mesh when performing rendering operations, the processor 15 may require more draw calls (i.e., rendering cost) when rendering the virtual character containing customized body parts.

In addition, when the character level of detail corresponds to a range of a skeletal model, the body parts of the virtual character that are located in the range can be rigged to the skeleton of the virtual character, and the processor 15 may generate corresponding character animation and rendering for a part of the range corresponding to the skeletal model (e.g., the upper body area of the avatar, the lower body area of the avatar). For example, the processor 15 may use Inverse Kinematics calculation and skeletal animation technology to generate the animation of the virtual character.

In some embodiments, when the virtual character corresponds to a full range of the skeletal model, since each body part can be rigged to the skeleton of the virtual character, the processor 15 may generate corresponding virtual character animation and rendering for all of the skeletal model.

Finally, in the present embodiment, the processor 15 may generate a real-time rendering of each of the virtual characters based on the rendering level corresponding to each of the virtual characters.

For example, when the processor 15 determines that the rendering level of a virtual character corresponds to a first character level of detail, the processor 15 may use the details defined by the first character level of detail (i.e., the range of the customized body part and the skeletal model, etc.) to render the virtual character.

It shall be appreciated that the real-time rendering referred to in the present disclosure is configured to render the 3D model/mesh corresponding to the virtual character. In addition, due to the different details that need to be processed, the processor 15 needs to spend different rendering costs for different character level of detail. Generally speaking, when the processor 15 needs to render more parts and details (e.g., more customized body parts, a larger range of the skeletal model), the rendering cost is higher.

In some embodiments, the real-time rendering operation target referred to in the present disclosure refers to the body parts of the virtual character or the clothes on the body.

In some embodiments, in order to reduce the cost of rendering, different character level of detail can further be corresponding to different ranges of body parts (e.g., only show the upper body part of the virtual character or the lower body part of the virtual character). For example, when the virtual character is far away, a coarsest character level of detail can be used, and the coarsest character level of detail only presents the upper body part of the virtual character, reducing the range of the body part to be rendered.

In some embodiments, the plurality of character level of detail comprise at least a first character level of detail and a second character level of detail, the first character level of detail corresponds to a first customized body part and a first skeletal model, the second character level of detail corresponds to a second customized body part and a second skeletal model. In some embodiments, the second customized body part is at least a part of the first customized body part, and the second skeletal model is at least a part of the first skeletal model.

In some embodiments, the plurality of character level of detail further comprise at least a third character level of detail, the third character level of detail corresponds to a third customized body part and a third skeletal model, the third skeletal model is at least a part of the second skeletal model, the range corresponding to the third customized body part is zero.

In some embodiments, the plurality of character level of detail further comprise at least a fourth character level of detail, the fourth character level of detail corresponds to a fourth customized body part and a fourth skeletal model, the range corresponding to the fourth customized body part is zero, the range corresponding to the fourth skeletal model is zero.

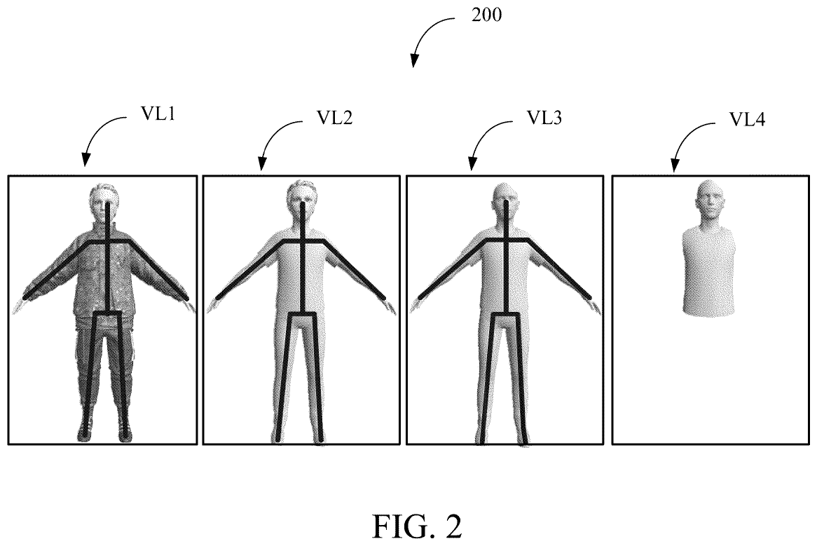

For ease of understanding, a practical example is used for illustration, please refer to FIG. 2. In FIG. 2, the character level of detail schematic diagram 200 illustrates at least four character level of detail VL1, VL2, VL3, VL4. In the present example, the highest character level of detail VL1 corresponds to a full range of customized body parts and a full range of the skeletal model (i.e., the processor 15 needs to render a full range of customized body parts and a full range of the skeletal model).

In the present example, the character level of detail VL2 corresponds to only the customized body parts of the head range and a full range of the skeletal model, and other body parts not in the head range are rendered with the preset template (e.g., rendered with a preset unified template). For example, the processor 15 may rig the template model to the skeleton of the virtual character for rendering.

In the present example, all body parts of the character level of detail VL3 are rendered with the preset template (i.e., there are no body parts that can be customized, and the range is 0), and the character level of detail VL3 corresponds to the full range of skeletal model.

In the present example, all body parts of the character level of detail VL4 are rendered with a preset template, and only the upper body parts of the virtual character are presented, and the character level of detail VL4 does not have a corresponding skeletal model (i.e., the range is 0). In other words, a virtual character whose rendering level is character level of detail VL4 will only render the upper body parts and will not have corresponding character motions.

It shall be appreciated that FIG. 2 is only for illustration, and the present disclosure does not limit the number and content of the character level of detail, so the number and content of the character level of detail can be set or adjusted according to actual operation. Those with ordinary knowledge in the technical field of this case should be able to understand the operations of the character level of detail corresponding to different number and contents according to the foregoing description.

In some embodiments, the processor 15 may also assign different appearance rendering levels to different character level of detail (e.g., select one level from a plurality of appearance level of detail). Specifically, the processor 15 determines an appearance rendering level corresponding to each of plurality of character level of detail based on a plurality of appearance level of detail, wherein each of the plurality of appearance level of detail corresponds to a rendering polygon number. Next, the processor 15 generates the real-time rendering of each of the virtual characters based on the rendering level and the appearance rendering level corresponding to each of the virtual characters.

For example, the character level of detail VL1 can correspond to the appearance rendering levels LOD1, LOD2 and LOD3, the appearance rendering level LOD1 is composed of 69451 polygons, the appearance rendering level LOD2 is composed of 2502 polygons, the appearance rendering level LOD3 is composed of 251 polygons. When the virtual character occupies a small area on the user's display screen, the processor 15 can use the coarsest appearance rendering level to render the virtual character (i.e., the least number of polygons), thus helping to save appearance rendering cost.

In some embodiments, the processor 15 can generate corresponding classification rules, and the classification rules indicate the importance degree of each virtual character and the virtual character operated by the user.

In some embodiments, the classification rule is generated based on a regional relationship between each of the virtual characters to the first virtual character.

In some embodiments, the operation of generating the regional relationship between each of the virtual characters and the first virtual character comprises the following operations. First, the processor 15 generates a region node graph based on a plurality of regions and a connection relationship corresponding to the regions, wherein the region node graph comprises a plurality of nodes. Next, the processor 15 assigns a distance relationship value corresponding to each of the regions based on the region node graph and a minimum node distance value between a first region of the first virtual character and each of the regions. Finally, the processor 15 classifies the virtual characters into the regions to generate the regional relationship between each of the virtual characters and the first virtual character based on position information comprised in each of the character motion data and the distance relationship value corresponding to each of the regions.

In some embodiments, since the virtual characters located in the same region have the same spatial relationship (i.e., with the same distance relationship value) as the virtual characters operated by the user, the virtual characters located in the same region correspond to the same rendering level.

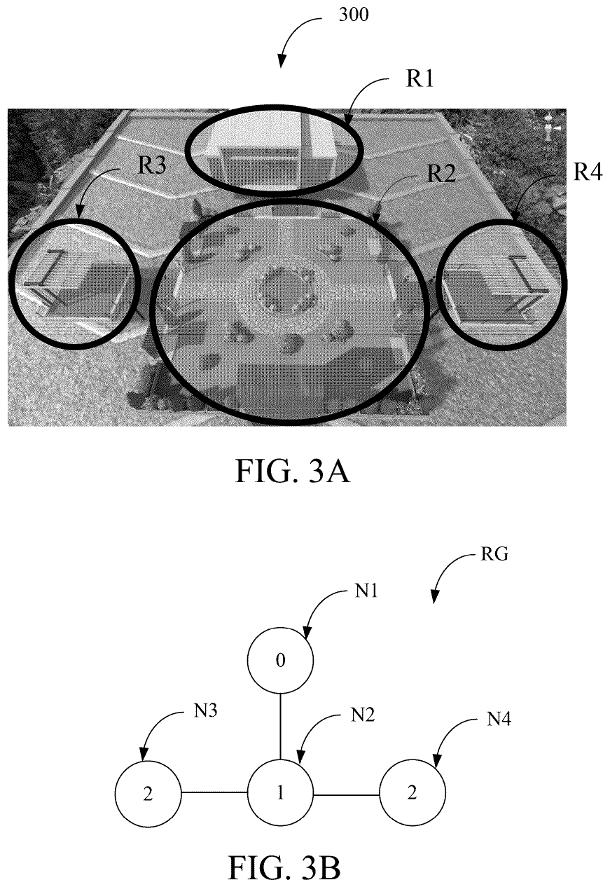

For ease of understanding, a practical example is used for illustration, please refer to FIG. 3A and FIG. 3B. FIG. 3A illustrates a regions schematic diagram 300 in a virtual reality environment. The virtual reality environment comprises a region R1, a region R2, a region R3 and a region R4, and each of the regions R2 and the regions R1, R3 and R4 is connected by a path. In addition, FIG. 3B illustrates a region node graph RG corresponding to the region schematic diagram 300, and the region node graph RG comprises nodes N1, N2, N3, N4 and corresponding connection relationships.

In the present example, the virtual character operated by the user (i.e., the first virtual character) is located in the region R1, so the distance relation value corresponding to the region R1 is 0. In addition, since the minimum node distance value between the node N2 and the node N1 is 1, the distance relation value corresponding to the region R2 is 1. In addition, since the minimum node distance value between the node N3 and the node N1 is 2, the distance relation value corresponding to the region R3 is 2. In addition, since the minimum node distance value between the node N4 and the node N1 is 2, the distance relation value corresponding to the region R4 is 2.

In the present example, when the virtual character is located in the region R1, the processor 15 sets the rendering level of the virtual character to VL1 (i.e., the highest character level of detail). When the virtual character is located in the region R2, the processor 15 sets the rendering level of the virtual character to VL2 (i.e., the second highest character level of detail). When the virtual character is located in the region R3 or the region R4, the processor 15 sets the rendering level of the virtual character to VL3 (i.e., the third highest character level of detail).

In some embodiments, the processor 15 may further increase the rendering level corresponding to the virtual character that interacts with the first virtual character (i.e., the virtual character is more important to the first virtual character). Specifically, the processor 15 may determine an interaction state between the first virtual character and each of the virtual characters based on the character motion data. Then, the processor 15 adjusts the rendering level corresponding to each of the virtual characters based on the interaction states.

For example, when the processor 15 determines that the virtual character is talking with the first virtual character, the processor 15 may increase the rendering level of the virtual character.

In some embodiments, the processor 15 may determine the rendering level corresponding to each virtual character based on the proportion of the virtual character on the user's display screen. For example, for the virtual character whose area ratio on the display screen is 80-100%, the processor 15 sets the rendering level of the virtual character to VL1 (i.e., the highest character level of detail). For the virtual character whose area ratio on the display screen is 50-79%, the processor 15 sets the rendering level of the virtual character to VL2 (i.e., the second highest character level of detail).

In some embodiments, the processor 15 may determine the rendering level corresponding to each virtual character based on one or a combination of the following three factors: (i) the interaction state between the virtual character and the virtual character of the local user, (ii) the spatial relationship between the virtual character and the virtual character of the local user, and (iii) the proportion of the virtual character on the user's display screen.

In some embodiments, the processor 15 can also adjust the rendering level corresponding to each of the virtual characters based on the remaining computing resources of the current apparatus.

According to the above descriptions, the real-time rendering generating apparatus 1 provided by the present disclosure determines the rendering level of each of a plurality of virtual characters through the corresponding relationship with the user's virtual character. Next, the real-time rendering generating apparatus 1 provided in the present disclosure can generate the real-time rendering of each of the virtual characters based on the rendering level corresponding to each of the virtual characters. Since the real-time rendering generating apparatus 1 provided by the present disclosure can classify/assign different rendering levels based on the importance degree between the virtual characters and the virtual character operated by the user, and allows to generate the real-time rendering for each virtual characters based on its own rendering level, and thus the rendering cost of the virtual character is reduced.

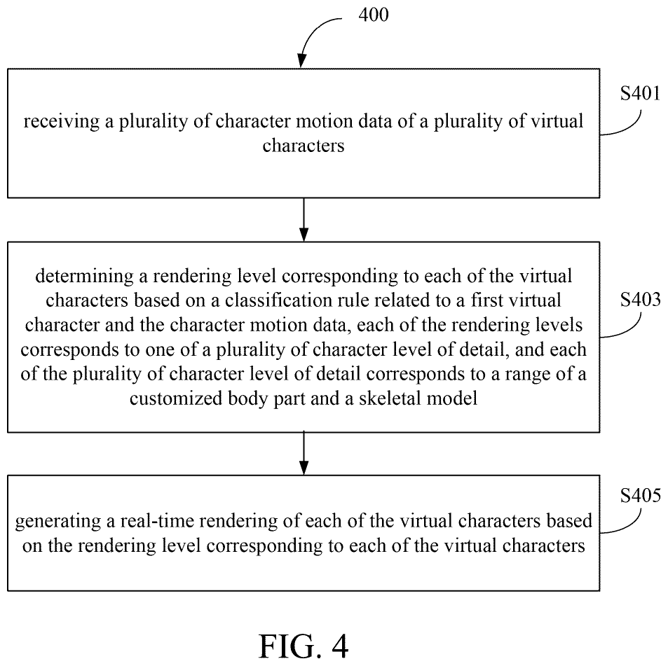

A second embodiment of the present disclosure is a real-time rendering generating method and a flowchart thereof is depicted in FIG. 4. The real-time rendering generating method 400 is adapted for an electronic apparatus (e.g., the real-time rendering generating apparatus 1 of the first embodiment). The real-time rendering generating method 400 generates a real-time rendering of each of the virtual characters through the steps S401 to S405.

In the step S401, the electronic apparatus receives a plurality of character motion data of a plurality of virtual characters.

Next, in the step S403, the electronic apparatus determines a rendering level corresponding to each of the virtual characters based on a classification rule related to a first virtual character and the character motion data, each of the rendering levels corresponds to one of a plurality of character level of detail, and each of the plurality of character level of detail corresponds to a range of a customized body part and a skeletal model.

Finally, in the step S405, the electronic apparatus generates a real-time rendering of each of the virtual characters based on the rendering level corresponding to each of the virtual characters.

In some embodiments, the classification rule is generated based on a regional relationship between each of the virtual characters to the first virtual character.

In some embodiments, the step of generating the regional relationship between each of the virtual characters and the first virtual character comprises the following steps: generating a region node graph based on a plurality of regions and a connection relationship corresponding to the regions, wherein the region node graph comprises a plurality of nodes; assigning a distance relationship value corresponding to each of the regions based on the region node graph and a minimum node distance value between a first region of the first virtual character and each of the regions; and classifying the virtual characters into the regions to generate the regional relationship between each of the virtual characters and the first virtual character based on a position information comprised in each of the character motion data and the distance relationship value corresponding to each of the regions.

In some embodiments, the virtual characters located in the same area correspond to the same rendering level.

In some embodiments, the real-time rendering generating method 400 further comprises the following steps: determining an interaction state between the first virtual character and each of the virtual characters based on the character motion data; and adjusting the rendering level corresponding to each of the virtual characters based on the interaction states.

In some embodiments, the plurality of character level of detail comprise at least a first character level of detail and a second character level of detail, the first character level of detail corresponds to a first customized body part and a first skeletal model, the second character level of detail corresponds to a second customized body part and a second skeletal model. In some embodiments, the second customized body part is at least a part of the first customized body part, and the second skeletal model is at least a part of the first skeletal model.

In some embodiments, the plurality of character level of detail further comprise at least a third character level of detail, the third character level of detail corresponds to a third customized body part and a third skeletal model, the third skeletal model is at least a part of the second skeletal model, the range corresponding to the third customized body part is zero.

In some embodiments, the plurality of character level of detail further comprise at least a fourth character level of detail, the fourth character level of detail corresponds to a fourth customized body part and a fourth skeletal model, the range corresponding to the fourth customized body part is zero, the range corresponding to the fourth skeletal model is zero.

In addition to the aforesaid steps, the second embodiment can also execute all the operations and steps of the real-time rendering generating apparatus 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

The real-time rendering generating method described in the second embodiment may be implemented by a computer program having a plurality of codes. The computer program may be a file that can be transmitted over the network, or may be stored into a non-transitory computer readable storage medium. After the codes of the computer program are loaded into an electronic apparatus (e.g., the real-time rendering generating apparatus 1), the computer program executes the real-time rendering generating method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

It shall be appreciated that in the specification and the claims of the present disclosure, some words (e.g., the virtual character, the character level of detail, the customized body part, and the skeletal model) are preceded by terms such as “first”, “second”, “third”, or “fourth”, and these terms of “first”, “second”, “third”, or “fourth” are only used to distinguish these different words. For example, the “first” and “second” character level of detail are only used to indicate the character level of detail used in different operations.

According to the above descriptions, the real-time rendering generating technology (at least including the apparatus, the method, and the non-transitory computer readable storage medium) provided by the present disclosure determines the rendering level of each of a plurality of virtual characters through the corresponding relationship with the user's virtual character. Next, the real-time rendering generating technology provided in the present disclosure can generate the real-time rendering of each of the virtual characters based on the rendering level corresponding to each of the virtual characters. Since the real-time rendering generating technology provided by the present disclosure can classify/assign different rendering levels based on the importance degree between the virtual characters and the virtual character operated by the user, and allows to generate the real-time rendering for each virtual characters based on its own rendering level, and thus the rendering cost of the virtual character is reduced.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A real-time rendering generating apparatus, comprising:
a transceiver interface;
a storage; and
a processor, being electrically connected to the transceiver interface and the storage, and being configured to perform operations comprising:
receiving a plurality of character motion data of a plurality of virtual characters;
determining a rendering level corresponding to each of the virtual characters based on a classification rule related to a first virtual character and the character motion data, wherein each of the rendering levels corresponds to one of a plurality of character level of detail, and each of the plurality of character level of detail corresponds to a range of a customized body part and a skeletal model; and
generating a real-time rendering of each of the virtual characters based on the rendering level corresponding to each of the virtual characters.

2. The real-time rendering generating apparatus of claim 1, wherein the classification rule is generated based on a regional relationship between each of the virtual characters to the first virtual character.

3. The real-time rendering generating apparatus of claim 2, wherein the operation of generating the regional relationship between each of the virtual characters and the first virtual character comprises the following operations:
generating a region node graph based on a plurality of regions and a connection relationship corresponding to the regions, wherein the region node graph comprises a plurality of nodes;
assigning a distance relationship value corresponding to each of the regions based on the region node graph and a minimum node distance value between a first region of the first virtual character and each of the regions; and
classifying the virtual characters into the regions to generate the regional relationship between each of the virtual characters and the first virtual character based on a position information comprised in each of the character motion data and the distance relationship value corresponding to each of the regions.

4. The real-time rendering generating apparatus of claim 3, wherein the virtual characters located in the same area correspond to the same rendering level.

5. The real-time rendering generating apparatus of claim 1, wherein the processor is further configured to perform the following operations:
determining an interaction state between the first virtual character and each of the virtual characters based on the character motion data; and
adjusting the rendering level corresponding to each of the virtual characters based on the interaction states.

6. The real-time rendering generating apparatus of claim 1, wherein the plurality of character level of detail comprise at least a first character level of detail and a second character level of detail, the first character level of detail corresponds to a first customized body part and a first skeletal model, the second character level of detail corresponds to a second customized body part and a second skeletal model.

7. The real-time rendering generating apparatus of claim 6, wherein the second customized body part is at least a part of the first customized body part, and the second skeletal model is at least a part of the first skeletal model.

8. The real-time rendering generating apparatus of claim 6, wherein the plurality of character level of detail further comprise at least a third character level of detail, the third character level of detail corresponds to a third customized body part and a third skeletal model, the third skeletal model is at least a part of the second skeletal model, the range corresponding to the third customized body part is zero.

9. The real-time rendering generating apparatus of claim 6, wherein the plurality of character level of detail further comprise at least a fourth character level of detail, the fourth character level of detail corresponds to a fourth customized body part and a fourth skeletal model, the range corresponding to the fourth customized body part is zero, the range corresponding to the fourth skeletal model is zero.

10. The real-time rendering generating apparatus of claim 1, wherein the processor is further configured to perform the following operations:
determining an appearance rendering level corresponding to each of the plurality of character level of detail based on a plurality of appearance level of detail, wherein each of the plurality of appearance level of detail corresponds to a rendering polygon number; and
generating the real-time rendering of each of the virtual characters based on the rendering level and the appearance rendering level corresponding to each of the virtual characters.

11. A real-time rendering generating method, being adapted for use in an electronic apparatus, and the real-time rendering generating method comprises:
receiving a plurality of character motion data of a plurality of virtual characters;
determining a rendering level corresponding to each of the virtual characters based on a classification rule related to a first virtual character and the character motion data, wherein each of the rendering levels corresponds to one of a plurality of character level of detail, and each of the plurality of character level of detail corresponds to a range of a customized body part and a skeletal model; and
generating a real-time rendering of each of the virtual characters based on the rendering level corresponding to each of the virtual characters.

12. The real-time rendering generating method of claim 11, wherein the classification rule is generated based on a regional relationship between each of the virtual characters to the first virtual character.

13. The real-time rendering generating method of claim 12, wherein the step of generating the regional relationship between each of the virtual characters and the first virtual character comprises the following steps:
generating a region node graph based on a plurality of regions and a connection relationship corresponding to the regions, wherein the region node graph comprises a plurality of nodes;
assigning a distance relationship value corresponding to each of the regions based on the region node graph and a minimum node distance value between a first region of the first virtual character and each of the regions; and
classifying the virtual characters into the regions to generate the regional relationship between each of the virtual characters and the first virtual character based on a position information comprised in each of the character motion data and the distance relationship value corresponding to each of the regions.

14. The real-time rendering generating method of claim 13, wherein the virtual characters located in the same area correspond to the same rendering level.

15. The real-time rendering generating method of claim 11, wherein the real-time rendering generating method further comprises the following steps:
determining an interaction state between the first virtual character and each of the virtual characters based on the character motion data; and
adjusting the rendering level corresponding to each of the virtual characters based on the interaction states.

16. The real-time rendering generating method of claim 11, wherein the plurality of character level of detail comprise at least a first character level of detail and a second character level of detail, the first character level of detail corresponds to a first customized body part and a first skeletal model, the second character level of detail corresponds to a second customized body part and a second skeletal model.

17. The real-time rendering generating method of claim 16, wherein the second customized body part is at least a part of the first customized body part, and the second skeletal model is at least a part of the first skeletal model.

18. The real-time rendering generating method of claim 16, wherein the plurality of character level of detail further comprise at least a third character level of detail, the third character level of detail corresponds to a third customized body part and a third skeletal model, the third skeletal model is at least a part of the second skeletal model, the range corresponding to the third customized body part is zero.

19. The real-time rendering generating method of claim 16, wherein the plurality of character level of detail further comprise at least a fourth character level of detail, the fourth character level of detail corresponds to a fourth customized body part and a fourth skeletal model, the range corresponding to the fourth customized body part is zero, the range corresponding to the fourth skeletal model is zero.

20. A non-transitory computer readable storage medium, having a computer program stored therein, wherein the computer program comprises a plurality of codes, the computer program executes a real-time rendering generating method after being loaded into an electronic apparatus, the real-time rendering generating method comprises:
receiving a plurality of character motion data of a plurality of virtual characters;
determining a rendering level corresponding to each of the virtual characters based on a classification rule related to a first virtual character and the character motion data, wherein each of the rendering levels corresponds to one of a plurality of character level of detail, and each of the plurality of character level of detail corresponds to a range of a customized body part and a skeletal model; and
generating a real-time rendering of each of the virtual characters based on the rendering level corresponding to each of the virtual characters.
